(19) United States
(12) Patent Application Publication
(10) Pub. No.: US 2026/0313731 A1
(43) Pub. Date: Oct. 8, 2026

(54) ULTRA HIGH RELIABILITY CRITICAL PARAMETER UPDATE SIGNALING

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(21) Appl. No.: 19/642,279

(22) Filed: Apr. 8, 2026

Related U.S. Application Data
(60) Provisional application No. 63/800,890, filed on May 6, 2025.
(60) Provisional application No. 63/791,163, filed on Apr. 18, 2025.
(60) Provisional application No. 63/785,327, filed on Apr. 8, 2025.

(51) Int. Cl. H04W 76/15

(52) U.S. Cl. CPC H04W 76/15

(57) ABSTRACT

Ultra High Reliability (UHR) critical parameter update signaling may be provided. The signaling includes receiving, at an access point (AP) multi-link device (MLD), an indication of a critical update to a UHR mode of operation, the critical update affecting a first affiliated AP of the AP MLD. Responsive to the indication, a value of a UHR critical update flag is set and a UHR BPCC value corresponding to the first affiliated AP is incremented. First management frames are encoded for transmission by the first affiliated AP, the management frames including information indicating the value of the UHR critical update flag and a critical parameter update element. The first affiliated AP transmits the first management frames. Second management frames are encoded for transmission by a second affiliated AP of the AP MLD. The second affiliated AP transmits the second management frames.

### RELATED APPLICATIONS

Under provisions of 35 U.S.C. § 119(e), Applicant claims the benefit of and priority to U.S. Provisional Application No. 63/785,327, filed Apr. 8, 2025, U.S. Provisional Application No. 63/791,163, filed Apr. 18, 2025, and U.S. Provisional Application No. 63/800,890, filed May. 6, 2025, the disclosures of which are incorporated herein by reference in their entirety.

### TECHNICAL FIELD

The present disclosure relates generally to providing Ultra High Reliability (UHR) critical parameter update signaling.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Ultra High Reliability (UHR) critical update signaling in accordance with aspects of the present disclosure.

FIG. 2 illustrates a first example Critical Parameters Update element in accordance with aspects of the present disclosure.

FIG. 3 illustrates a second example Critical Parameters Update element in accordance with aspects of the present disclosure.

FIG. 4 illustrates a Critical Parameters Update Multi-Link element in accordance with aspects of the present disclosure.

FIG. 5 illustrates a Per-STA Profile of the Critical Parameters Update Multi-Link element in accordance with aspects of the present disclosure.

FIG. 6 illustrates a UHR Operation Parameters Element in accordance with aspects of the present disclosure.

FIG. 7 illustrates a Capability Information field in accordance with aspects of the present disclosure.

FIG. 8 illustrates a Common Info field of a Basic Multi-Link element in accordance with aspects of the present disclosure.

FIG. 9 illustrates a Reduced Neighbor Report element in accordance with aspects of the present disclosure.

FIG. 10 illustrates a method for UHR critical update signaling in accordance with aspects of the present disclosure.

FIG. 11 illustrates another method for UHR critical update signaling in accordance with aspects of the present disclosure.

FIG. 12 is a block diagram of a computing device in accordance with aspects of the present disclosure.

FIG. 13 is a block diagram of a communications device in accordance with aspects of the present disclosure.

### DETAILED DESCRIPTION

### Overview

Ultra High Reliability (UHR) critical parameter update signaling may be provided. The signaling includes receiving, at an access point (AP) multi-link device (MLD), an indication of a critical update to a UHR mode of operation, the critical update affecting a first affiliated AP of the AP MLD. Responsive to the indication, a value of a UHR critical update flag is set and a UHR BPCC value corresponding to the first affiliated AP is incremented. First management frames are encoded for transmission by the first affiliated AP, the management frames including information indicating the value of the UHR critical update flag and a critical parameter update element. The first affiliated AP transmits the first management frames. Second management frames are encoded for transmission by a second affiliated AP of the AP MLD. The second affiliated AP transmits the second management frames.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

For many Ultra High Reliability (UHR) operations, access points (APs) need to provide advance notification to Stations (STAs) (i.e., non-AP Multi-Link Devices (MLDs)) before making critical updates effective. This advance notification helps STAs better prepare for the configuration changes caused by those updates. The notification should also persist for a sufficient duration so that STAs can receive the updates even when they intermittently sleep, ignore some frames, or are otherwise temporarily unavailable. This process extends the advance notification mechanism defined for Extremely High Throughput (EHT) (Wi-Fi 7), which provided advance notification for AP removal using a Reconfiguration element and for AP link enable/disable using a Traffic Identifier (TID)-to-Link Mapping element. In UHR, a broader range of operating modes are subject to critical updates, requiring a more general and flexible critical update notification and parameter signaling framework.

A second, related problem arises once a critical update has become effective. After the effective time, some STAs, such as those that were in deep sleep during the pre-effective notification period (also referred to as the advance notification period), may wake up without knowledge of the updated parameters and initiate individual probe request/response exchanges (or other individual frame exchanges) to retrieve them. If many such STAs do so concurrently or over a short period, this can result in a probe storm or storm of requests from STAs that could significantly degrade network performance. Accordingly, updated basic service set (BSS) parameters must continue to be advertised in Beacon frames for a duration after the critical update becomes effective, enabling those STAs to obtain the updated parameters passively and without individual querying.

Example operations that require advance notification include enabling or disabling operating modes, or updating associated operating mode parameters, for operating modes including Dynamic Power Save (DPS), Dynamic Unavailability Operation (DUO), Periodic Unavailability Operation (PUO), AP Periodic Power Save (AP PPS), Non-Primary Channel Access (NPCA), Dynamic Subchannel Operation (DSO), Dynamic Bandwidth Expansion (DBE), and Prioritized Enhanced Distributed Channel Access (P-EDCA), among others. Critical updates may further include UHR per-link updates, UHR per-MLD updates (e.g., updates to MLD-level capability), and updates to the AP’s Basic UHR Modulation and Coding Scheme (MCS) and Number of Spatial Streams (NSS) Set.

Procedures and signaling for providing critical update notifications and updated UHR operating parameters to STAs are described herein. APs can provide critical updates in management frames such as Beacon frames, Probe Response frames, Link Reconfiguration Response frames, Link Reconfiguration Notify frames and (Re)Association Response frames. The occurrence of a critical update is signaled using a UHR Critical Update Flag (CUF) and a UHR BSS Parameters Change Count (BPCC). The UHR CUF is set to a value (e.g., 1) and the UHR BPCC is incremented when a critical update is initiated. Critical updates to operation modes and associated operating parameters are reported in a Critical Parameters Update (CPU) element in these frames. Inclusion of a Critical Parameters Update (CPU) element in a Beacon or Probe Response frame is treated as a critical update, and modification of the CPU element similarly constitutes a critical update triggering setting the CUF and updating the UHR BPCC. When the critical update actually takes effect at the time indicated in the CPU element, the UHR BPCC is not incremented again, as the UHR BPCC counter was already incremented when the CPU element was first added or modified.

The CPU element carries information associated with the critical updates and is included in management frames in advance of the updates becoming effective. After the critical update becomes effective, the same CPU element may continue to be carried in Beacon frames using a special value in the Critical Update Switch Time field (e.g., a value of zero or another value) to indicate that the update has already taken effect. In some embodiments, an AP may simultaneously include two CPU elements. One CPU element provides advance notification for an upcoming critical update (with the switch time field indicating a future effective time) and another CPU element provides updated parameters for a critical update that has already become effective (with a specific switch time value indicating this). In some embodiments, the duration for signaling critical updates, both before and after the effective time, is based on the listen intervals provided by STAs during association with the AP.

In addition to the CPU element, the UHR Operation element may be defined to carry UHR operating mode parameters. In steady-state Beacon frames (e.g., when no critical update is pending or has become recently effective), the UHR Operation element indicates only which operating modes are enabled or disabled, without carrying detailed operating parameters, in order to avoid beacon bloating. In Probe Response and (Re)Association Response frames, however, the UHR Operation element carries operating parameters for the enabled UHR operating modes, ensuring that STAs can obtain full operating mode parameters during association or individual probe exchange. When all updated parameters associated with a given critical update are present in the management frames, a UHR All Updates Included flag is set to indicate to receiving STAs that no further individual parameter fetching is necessary, since all the updated parameters are included in the current frame itself.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

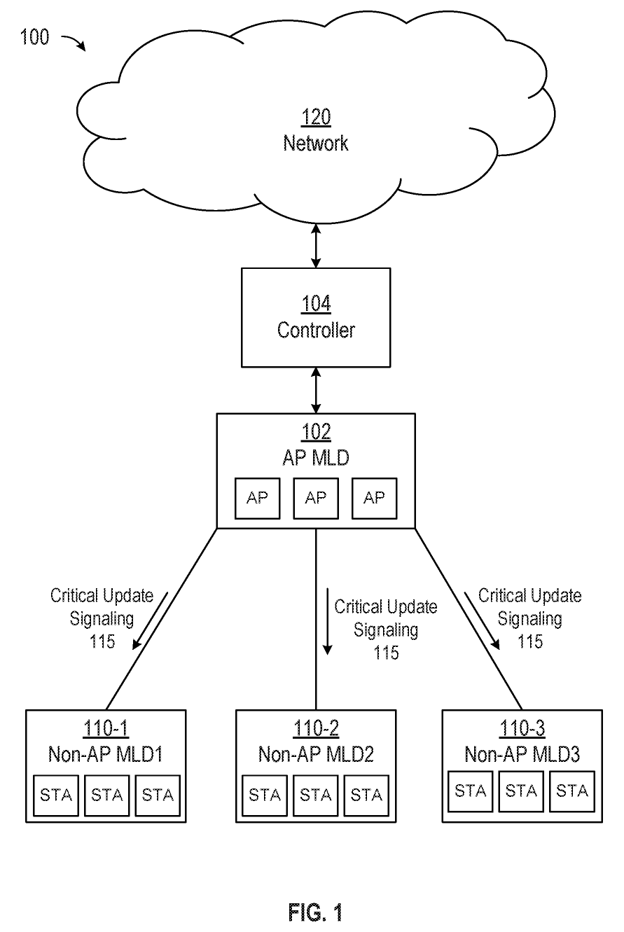

FIG. 1 is a block diagram of an operating environment 100 for UHR critical update signaling. The operating environment 100 includes an AP MLD 102, a controller 104, non-AP MLDs 110 (illustrated as non-AP MLD1 110-1, non-AP MLD2 110-2, and non-AP MLD3 110-3), and a network 120.

The AP MLD 102 is configured to communicate with and/or enable devices such as the non-AP MLDs 110 to wirelessly connect to the network 120. The controller 104 is a network controller, such as a Wireless Local Area Network (WLAN) controller, configured to manage and control the AP MLD 102, the non-AP MLDs 110, and/or other network devices to allow wireless devices to connect to and utilize the network 120. The AP MLD 102 and/or the controller 104 can include router components or connect to an external router for routing traffic and otherwise managing the operation of the WLAN. In certain embodiments, the AP MLD 102 acts as a controller and the controller 104 is not present in the operating environment 100. For example, the AP MLD 102 can include components to act as a WLAN controller.

The non-AP MLDs 110 are any client device, such as a smartphone, tablet, laptop, personal computer, or internet-of-things device. Different non-AP MLDs 110 may have different capabilities and operational characteristics, including different listen intervals, different beacon processing capabilities, and different power-saving behaviors that periodically affect their availability for receiving frames.

As shown in FIG. 1, the non-AP MLDs 110 and the AP MLD 102 are MLDs, and each includes one or more affiliated STAs (referred to as APs with respect to the AP MLD 102). The non-AP MLDs 110 use their affiliated STAs to form links with the affiliated APs of the AP MLD 102. Each affiliated STA/AP may include Physical (PHY)-layer and lower-Media Access Control (MAC) components. The MLDs may also include an upper-MAC for coordinating the multiple affiliated STAs/APs (or links) that are part of the MLD. The affiliated STAs/APs can use different frequency bands for various wireless links, including 2.4 Gigahertz (GHz), 5 GHz, 6 GHz, or other bands.

The network 120 is a set of devices that facilitate communication between senders and destinations, such as by implementing communication protocols. Example networks 120 include local area networks, wide area networks, intranets, or the Internet. In certain embodiments, the network 120 includes one or more systems for managing or otherwise controlling critical update signaling operations.

In operation, the AP MLD 102 implements critical update signaling 115 mechanisms to ensure that all associated non-AP MLDs 110 can reliably detect and receive critical network configuration changes. When a critical update occurs, the AP MLD 102 signals the update in advance, before it becomes effective, by including a CPU element in management frames such as Beacon frames and Probe Response frames. Adding or modifying the CPU element is treated as a critical update since this reflects changes to operation mode and/or operating parameters, causing the AP MLD 102 to set a UHR CUF value (e.g. set to 1) to indicate the update and increment a UHR BPPC value for the AP where the critical update occurs. The CPU element indicates the type or types of operating modes being updated, the time at which the critical update will take effect, and updated parameters for the affected operating modes. Non-AP MLDs 110 that are awake during the advance notification period for the critical update can receive these parameters directly from Beacon frames, while non-AP MLDs 110 that miss the advance notification for the critical update can acquire updated parameters individually through a Probe Request/Response exchange (or other frame exchanges) upon detecting a changed UHR BPCC.

After a critical update becomes effective, the AP MLD 102 may continue to carry the CPU element (e.g., using a special value in the Critical Update Switch Time field to indicate that the update has already taken effect) and/or uses a UHR Operation element to indicate the critical updates for a period of time sufficient to reach non-AP MLDs 110 that were in deep sleep during the pre-effective advance notification window. This continued advertisement prevents a storm of requests (e.g. storm of probe requests) that would otherwise result from many non-AP MLDs 110 issuing individual queries to fetch updated parameters within a short period of time. When all updated parameters associated with a critical update are included in the advertised management frames, a UHR All Updates Included flag is set to a value (e.g., 1) to inform non-AP MLDs 110 that no further individual parameter fetching is necessary, since all the updated parameters are included in the current frame itself.

Because the AP MLD 102 operates across multiple links, critical updates for a given link are signaled per-link, with the UHR CUF and UHR BPCC incremented for the affected link. Non-AP MLDs 110 monitoring other links of the AP MLD 102 are informed of the update through a Reduced Neighbor Report (RNR) element carrying the updated UHR BPCC for the affected link and, in some embodiments, through a Basic Multi-Link element that includes the CPU element in the Per-STA Profile corresponding to the affected link. The critical update signaling procedures and element formats described herein are described in further detail with respect to the other drawings.

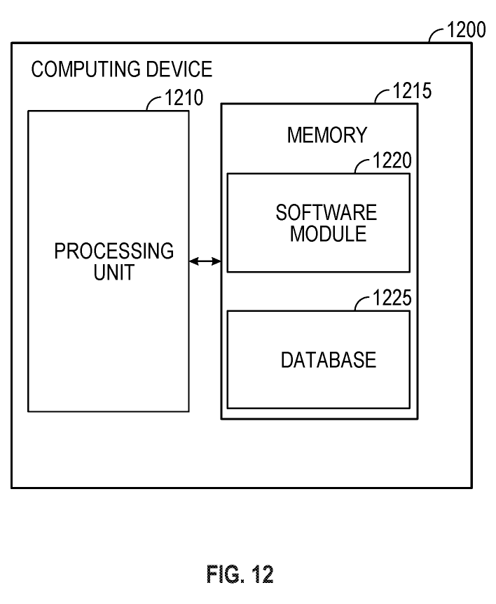

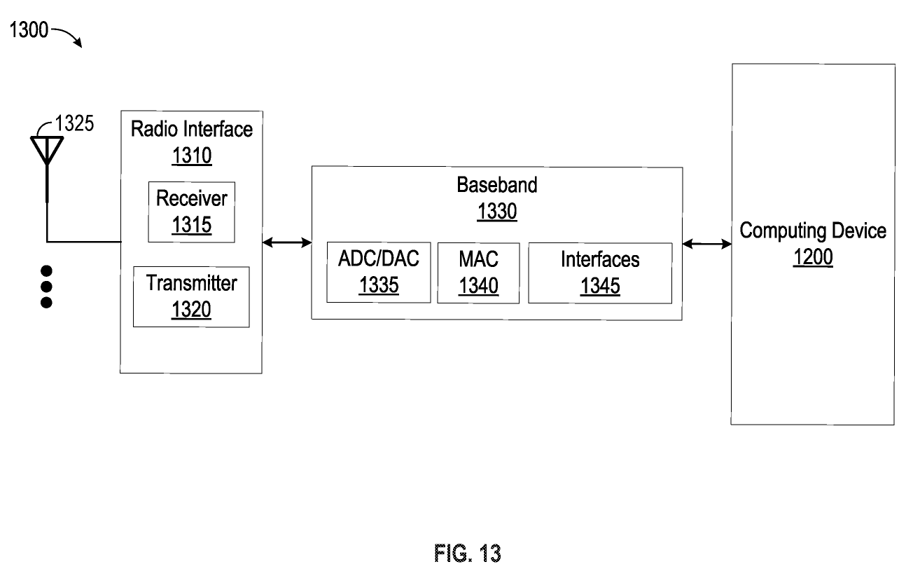

The elements described above of the operating environment 100 (e.g., the AP MLD 102, the controller 104, the non-AP MLDs 110, the devices of the network 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 12 and 13, the elements of the operating environment 100 may be practiced in a computing device 1200 and/or communications device 1300.

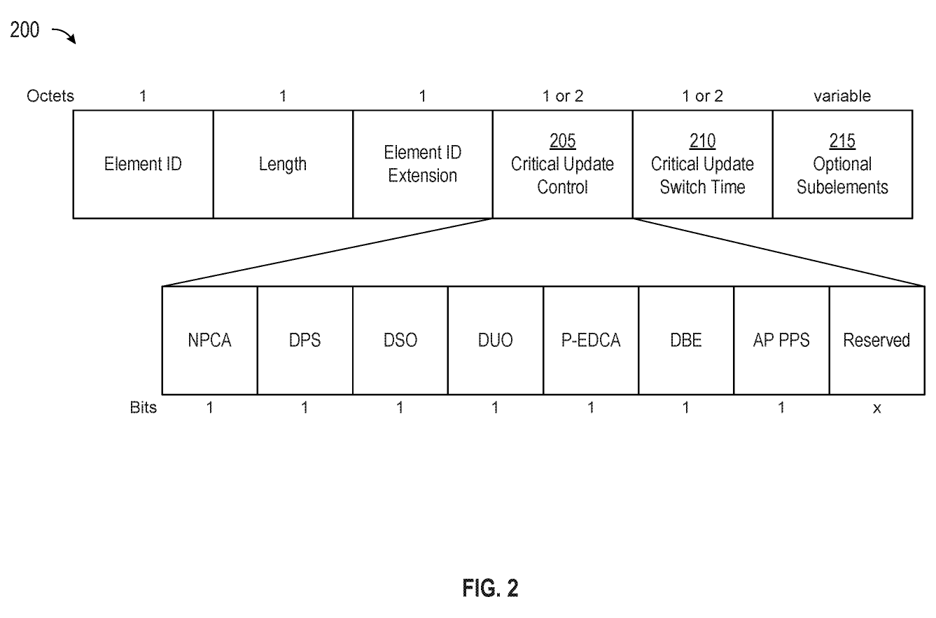

FIG. 2 illustrates a first example format of a CPU element 200. The AP MLD 102 announces pending critical updates to associated non-AP MLDs 110 by including the CPU element 200 in management frames such as Beacon frames, Probe Response frames, and (Re)Association Response frames.

As noted above, inclusion of the CPU element 200 in a frame is itself treated as a critical update, as is any modification to the CPU element 200. Accordingly, when the CPU element 200 is first added or subsequently modified, the UHR CUF is set to a value (e.g., 1) to indicate the presence of critical updates and the UHR BPCC is incremented. When the critical update actually takes effect at the switch time advertised in the CPU element 200, the UHR BPCC is not incremented again because it was already incremented when the CPU element 200 was first added or modified.

In addition to pre-effective notification, the CPU element 200 may be carried in Beacon frames, Probe Response frames, and other management frames for a period of time after the critical update has become effective. For this post-effective use, a special value (e.g., zero) is set in the Critical Update Switch Time field 210, described in further detail herein, to indicate to receiving non-AP MLDs 110 that the critical update has already taken effect and that the included parameters reflect the current operating configuration. In some embodiments, the AP MLD 102 simultaneously carries two CPU elements 200 in a Beacon frame. One CPU element 200 provides post-effective parameters for a critical update that has already taken effect (using the special switch time value), and a second CPU element 200 provides advance notification for a different critical update that has not yet taken effect (using a future switch time value). This dual-element approach allows the AP MLD 102 to concurrently serve non-AP MLDs 110 that missed an earlier critical update while also announcing a forthcoming critical update. Similarly, the same CPU element 200, with the special switch time value, may be included in Probe Response and (Re)Association Response frames to provide operating mode parameters to non-AP MLDs 110 outside of a critical update event.

The CPU element 200 indicates the type or types of critical update being announced via a Critical Update Control field 205. In one example format, the Critical Update Control field 205 is a bitmap in which each bit position corresponds to a specific UHR operating mode, such as NPCA, DPS, DSO, DUO, P-EDCA, DBE, and AP PPS. One value (e.g., 1) in a given bit position indicates that the corresponding operating mode is being enabled (or is currently enabled), and another value (e.g., 0) indicates that it is being disabled (or is currently disabled). When an operating mode is being enabled, updated parameters for that mode may be included in the Optional Subelements field 215. For critical updates where the type is provided by a dedicated field rather than a bitmap, a Critical Update Type field can instead be used to indicate which UHR operating mode is the subject of the critical update (e.g., NPCA, P-EDCA, or DBE). The Critical Update Type field can be referred to as a UHR Mode Type or a UHR Mode ID field. When multiple critical updates share the same effective time, multiple Critical Update Type fields (or UHR Mode ID fields) can be included in a single CPU element 200, with the Optional Subelements field 215 carrying parameters for each of the affected modes.

The Critical Update Switch Time field 210 indicates when the critical update will take effect. In one implementation, the field 210 specifies the number of Target Beacon Transmission Times (TBTTs) that will elapse before the critical update takes effect. For example, a value of five indicates that the update becomes effective at the fifth TBTT following the Beacon containing the CPU element 200. In another implementation, the field 210 specifies the switch time as a Timing Synchronization Function (TSF) time value in time units (TUs) based on the TSF of the current link, indicating the absolute TSF time at which the critical update becomes effective. This implementation is analogous to the approach used for TID-to-Link Mapping in EHT and provides the AP MLD 102 with greater flexibility to schedule critical updates at a precise time rather than at a TBTT boundary.

For certain critical updates, additional time beyond the switch time may be needed for the AP MLD 102 to complete the physical transition associated with the update. For example, an NPCA primary channel change or a DBE bandwidth change involves channel switching or center frequency retuning, and the AP MLD 102 may require some time after the switch time to complete the changeover. For these updates, the CPU element 200 includes a maximum time for critical update field, expressed for example in TUs, indicating the maximum duration the AP MLD 102 may take to complete the transition for the critical update after the switch time has passed.

Multiple critical updates that take effect at the same time can be announced within a single CPU element 200. If multiple critical updates are scheduled to take effect at different times, the AP MLD 102 includes separate CPU elements 200 (e.g., one element 200 per distinct switch time) in the same Beacon frame. In example implementations, two CPU elements 200 with distinct future switch times may be included to announce two concurrently pending critical updates that take effect at different times.

In example implementations, the CPU element 200 provides critical update notification for a single link or affiliated AP only of an AP MLD. When a critical update occurs for a given link or affiliated AP, the CPU element 200 is included or modified in the Beacon for that link/affiliated AP, the UHR CUF for the given link is set to the value to indicate updates (e.g., 1), and the UHR BPCC for the given link is incremented. Non-AP MLDs 110 operating on other links of the AP MLD 102 can be informed of the update on the given link in two ways. First, the RNR element carried on the other links reflects the updated UHR BPCC for the given link. Second, the Basic Multi-Link element carried in Beacon frames on the other links includes the CPU element 200 in the Per-STA Profile corresponding to the given link, so that non-AP MLDs 110 monitoring those links can read the full critical update notification for the given link directly (without requiring the non-AP MLD to monitor the given link). When all updated parameters associated with the critical update are present in the Beacon, the UHR All Updates Included flag is set to 1, signaling to non-AP MLDs 110 that no individual frame exchange (e.g. Probe Request/Response exchange) is necessary to retrieve the updated parameters.

In other embodiments, the CPU element 200 supports cross-link critical update signaling by including a Link ID field that identifies the link to which the CPU element 200 applies. Under this approach, a Beacon frame on a given link may simultaneously include one CPU element 200 for that link and one or more additional CPU elements 200 for other links of the AP MLD 102, each carrying the Link ID of the respective target link. The timing information in each CPU element 200 is relative to the link identified by the Link ID field. This approach achieves cross-link notification without embedding the CPU element 200 in a Per-STA Profile of a Basic Multi-Link element, and thus avoids potential interoperability issues with non-UHR STAs that may show compatibility issues new elements appearing in a Per-STA Profile. The CPU element 200 format illustrated in FIG. 2 applies to both same link critical update signaling and cross-link critical update signaling. For cross-link critical update signaling, a Link ID information field can also be included.

In addition to UHR operating mode updates, the CPU element 200 also supports critical updates to the AP MLD’s Basic UHR MCS and NSS Set parameters. The Basic UHR MCS and NSS Set defines the minimum set of MCS and NSS set configurations that associated STAs must support to participate in the BSS. Under conventional operation, this set is static and no mechanism exists for the AP MLD 102 to notify associated non-AP MLDs 110 that the Basic UHR MCS and NSS Set will change.

The AP MLD 102 may, however, have valid operational reasons to update these parameters. For example, during low-traffic periods the AP MLD 102 may reduce its basic MCS and NSS requirements to conserve power, or the AP MLD 102 may lower the Basic UHR MCS and NSS Set as a result of splitting its radio resources across multiple links or across multiple wireless technologies operating concurrently. Without a critical update mechanism, such changes would occur without notification, potentially disrupting associated non-AP MLDs 110.

A key constraint governing any such update is that it must not affect pre-UHR (legacy) clients. Specifically, the AP MLD 102 must ensure that the Basic MCS and NSS Set as perceived by pre-UHR STAs does not change and only the UHR-specific Basic UHR MCS and NSS Set parameters are modified. This preserves backward compatibility with legacy devices that are incapable of processing UHR-defined critical update signaling.

In example implementations, updates to the Basic UHR MCS and NSS Set are performed using the same UHR critical update procedure described above for operating mode updates. The CPU element 200 supports this type of critical update by treating it as an additional critical update type (by defining a new value for the Critical Update Type field which is also referred to as a UHR Mode Type or a UHR Mode ID field) alongside the UHR operating mode types described above. For example, a new Critical Update Type value indicating ‘Basic UHR MCS and NSS Set parameters update’ can be defined. When the AP MLD 102 needs to update its Basic UHR MCS and NSS Set, it indicates this new Critical Update Type value in the CPU element 200 and includes the updated Basic UHR MCS and NSS Set parameters in the CPU element 200 e.g. in Optional Subelements field 215 and sets the Critical Update Switch Time field 210 to indicate the time at which the new parameters will become effective. Non-AP MLDs 110 receiving the CPU element 200 prior to the switch time can thereby prepare for the updated MCS and NSS requirements before they take effect.

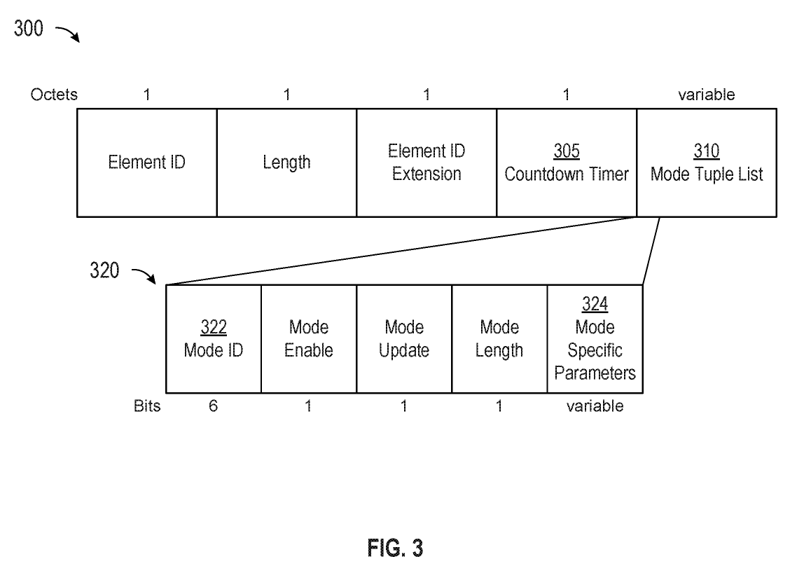

FIG. 3 illustrates a second example format of a CPU element 300. The CPU element 300 includes a Countdown Timer field 305 that is set to the number of TBTTs until the TBTT at which the critical updates take effect at the AP corresponding to the CPU element 300. For example, a Countdown Timer field 305 value of 1 indicates that the updates take effect at the next TBTT. The Countdown Timer field is equivalent to Critical Update Switch Time field 210.

A Mode Tuple List field 310 contains one or more Mode Tuple fields 320. Each Mode Tuple field 320 includes a Mode ID field 322 identifying the UHR operating mode associated with that tuple (this is equivalent to Critical Update Type field described above), a Mode Enable field indicating whether that operating mode is being enabled, a Mode Update field indicating whether parameters of the operating mode are being updated, a Mode Length field indicating the length of the Mode Specific Parameters field 324, and a Mode Specific Parameters field 324 carrying the specific updates to the operating mode, such as NPCA channel parameters, DBE bandwidth parameters, or other mode-specific configuration. The Mode Specific Parameters field 324 is equivalent to Optional Subelements 215 carrying operating parameters for UHR mode as described above.

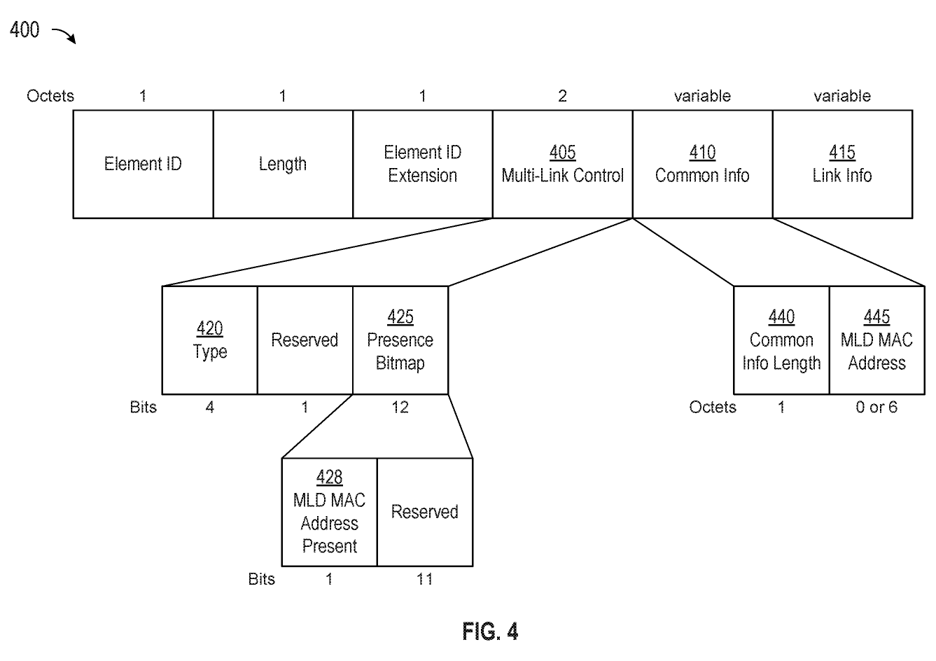

FIG. 4 illustrates an example CPU Multi-Link element 400, corresponding to an embodiment in which the CPU is defined as a Multi-Link element capable of carrying advance critical update notifications for multiple links within a single element structure. To implement the CPU Multi-Link element 400, either a new type value is defined for the EHT defined Multi-Link element or a new element ID is assigned for a separately defined ML-type element.

The CPU Multi-Link element 400 includes a Multi-Link Control field 405, a Common Info field 410, and a Link Info field 415. The Multi-Link Control field 405 includes a Type field 420 identifying the element as the CPU Multi-Link type, and a Presence Bitmap 425 containing a MLD MAC Address Present field 428 indicating whether the MLD MAC Address field is present in the Common Info field 410.

The Common Info field 410 includes a Common Info Length field 440 indicating the length of the Common Info field 410, and optionally a MLD MAC Address field 445 carrying the MLD MAC address when indicated as present by the Presence Bitmap 425.

The Link Info field 415 carries one or more Per-STA Profile subelements, each providing critical update parameters for a respective link. In certain embodiments, critical updates for the current link are also provided via a Per-STA Profile subelement rather than through the Common Info field 410, giving the CPU Multi-Link element 400 a uniform per-link structure regardless of whether the target link is the current link or another link of the AP MLD 102.

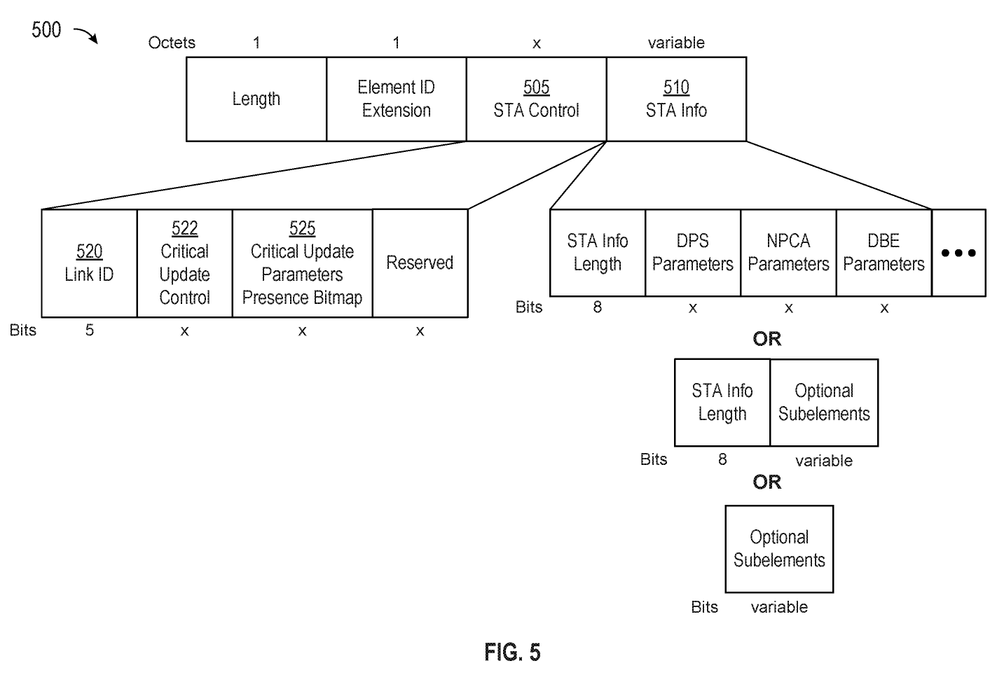

FIG. 5 illustrates an example Per-STA Profile subelement 500 of the CPU Multi-Link element 400. The Per-STA Profile subelement 500 includes a STA Control field 505 and a STA Info field 510.

The STA Control field 505 includes a Link ID field 520 identifying the link to which the Per-STA Profile subelement 500 applies, a Critical Update Control field 522 indicating the set of UHR operating modes for which critical updates are being announced (e.g., analogous in function to the Critical Update Control field 205 of the CPU element 200), and a Critical Update Parameters Presence Bitmap 525 containing a presence bit for each operating mode for which updated parameters are provided in the STA Info field 510.

The STA Info field 510 carries the critical update parameter details for each operating mode indicated in the STA Control field 505. The per-mode parameters may be organized either as separate dedicated fields for each operating mode (e.g., a discrete NPCA Operation Parameters field and a discrete DBE Operation Parameters field) or as separate subelements within an Optional Subelements field 550, with one subelement per operating mode. The Critical Update Parameters Presence Bitmap 525 determines which per-mode parameter fields or subelements are present in the STA Info field 510 for a given Per-STA Profile subelement 500.

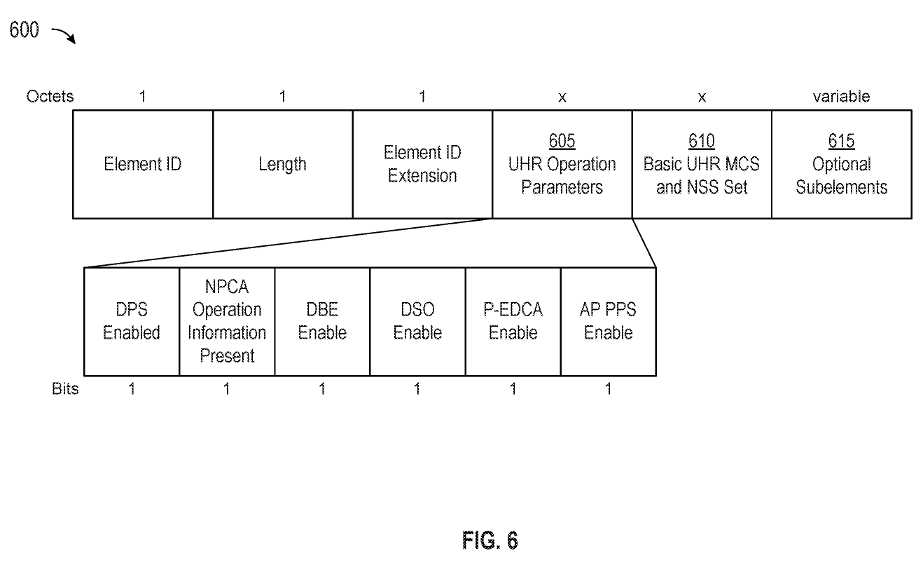

FIG. 6 illustrates a UHR Operation element 600. As described above with respect to FIG. 2, one embodiment for providing parameters after a critical update becomes effective is to continue carrying the CPU element in Beacon frames, using a special value in the Critical Update Switch Time field to indicate that the update has already taken effect. In an alternative embodiment, as described with respect to FIG. 6, once the critical update becomes effective the CPU element is no longer carried in Beacon frames, and the UHR Operation element 600 is used instead to carry the updated parameters for the affected operating modes. In either embodiment, the goal is to allow non-AP MLDs 110 that were in deep sleep during the pre-effective notification window to passively acquire updated parameters from Beacon frames, avoiding the requests that would result from many such devices issuing individual Probe Request/Response exchanges or other frame exchanges upon detecting a changed UHR BPCC.

The UHR Operation element 600 serves a dual role depending on the frame type in which it is carried. In Beacon frames during steady-state operation (e.g., when no critical update is pending or being advertised post-effectively), the UHR Operation element 600 is intentionally kept thin to avoid beacon bloating, carrying only enable/disable status for each UHR operating mode via the UHR Operation Parameters field 605 and does not include detailed per-mode parameters. In Probe Response frames and (Re)Association Response frames, however, the UHR Operation element 600 carries detailed operating mode parameters for all enabled modes, providing a newly associating or re-querying non-AP MLD 110 with the full current operating configuration. When carried in a Beacon frame for the purpose of post-effective critical update advertisement, the UHR Operation element 600 includes the updated parameters for the affected modes, serving the same function as the post-effective CPU element in the first embodiment.

As illustrated in FIG. 6, the UHR Operation element 600 includes a UHR Operation Parameters field 605, a Basic UHR MCS and NSS Set field 610, and an Optional Subelements field 615. The UHR Operation Parameters field 605 is a bitmap indicating the enabled or disabled status of each UHR operating mode. Each bit position in the field 605 corresponds to a specific UHR operating mode, for example, DPS, NPCA, DBE, DSO, P-EDCA, and AP PPS (also referred to as AP Periodic Unavailability or AP PUO). A value of 1 in a given bit position indicates that the corresponding mode is enabled, and a value of 0 indicates that it is disabled. In Probe Response and (Re)Association Response frames, when an operating mode is indicated as enabled in the UHR Operation Parameters field 605, the corresponding operating mode parameters are also present in the UHR Operation element 600 for that mode.

In one format, the per-mode parameters are carried as subelements in the Optional Subelements field 615. Each subelement corresponds to a specific UHR operating mode, such as an NPCA Parameters subelement, a DPS Parameters subelement, a DBE Parameters subelement, a P-EDCA Parameters subelement, and an AP PPS Parameters (or AP PUO) subelement, among others. In an alternative format, the per-mode parameters are included as a series of dedicated mode-specific fields directly within the UHR Operation element 600, rather than as subelements. Under this alternative, the presence of a specific mode’s parameter field is determined by the corresponding enable/disable bit in the UHR Operation Parameters field 605. If a mode is indicated as enabled, its parameter field is present. If a mode is disabled, the field is absent. In both formats, the UHR Operation Parameters field 605 bits indicating enable/disable of different modes can be in any order and can include a subset of UHR operating modes or additional operating modes beyond those enumerated above.

The Basic UHR MCS and NSS Set field 610 carries the basic set of MCS and NSS values required of associated non-AP MLDs 110 for the BSS. In some cases, the UHR Operation element 600 may omit the Basic UHR MCS and NSS Set field 610, with the presence of the field signaled by a dedicated presence bit. For example, in a Multiple BSSID deployment, the UHR Operation element 600 carried in the Non-Transmitted BSSID Profile of a non-transmitted BSS may omit the Basic UHR MCS and NSS Set field 610 because the non-transmitted BSS uses the same value as the transmitted BSSID, making repetition unnecessary. In example implementations, the Basic UHR MCS and NSS Set may alternatively be carried as a subelement in the Optional Subelements field 615 rather than as a standalone field.

When the UHR Operation element 600 is carried in a Beacon frame for the purpose of post-effective critical update advertisement, and when all updated parameters associated with the critical update that caused the last UHR BPCC increment are present in the UHR Operation element 600, the UHR All Updates Included flag is set to a value (e.g., 1). Non-AP MLDs 110 receiving a Beacon with this flag set to the value can confirm that the current Beacon contains all updated parameters and no individual Probe Request/Response exchange or another frame exchange is necessary to fetch the parameters. Non-AP MLDs 110 that did not receive the updates from the Beacon (e.g., because they were in deep sleep) will detect the changed UHR BPCC upon waking and initiate a Probe Request/Response exchange or another frame exchange to acquire the UHR Operation element 600 and its updated parameters.

The UHR Operation element 600 is carried in Probe Response and (Re)Association Response frames and includes the parameters for the operating modes, regardless of whether any critical update is pending or recently effective, because UHR operating mode parameters are needed by a non-AP MLD 110 at the time of association or re-association even in the absence of any critical update event. For other links of the AP MLD 102, the UHR Operation element 600 (with the parameters for the operating modes) can be included in the Per-STA Profile subelement of the Basic Multi-Link element carried in Probe Response and (Re)Association Response frames, providing the non-AP MLD 110 with UHR operating mode parameters for all links of the AP MLD 102 in a single exchange.

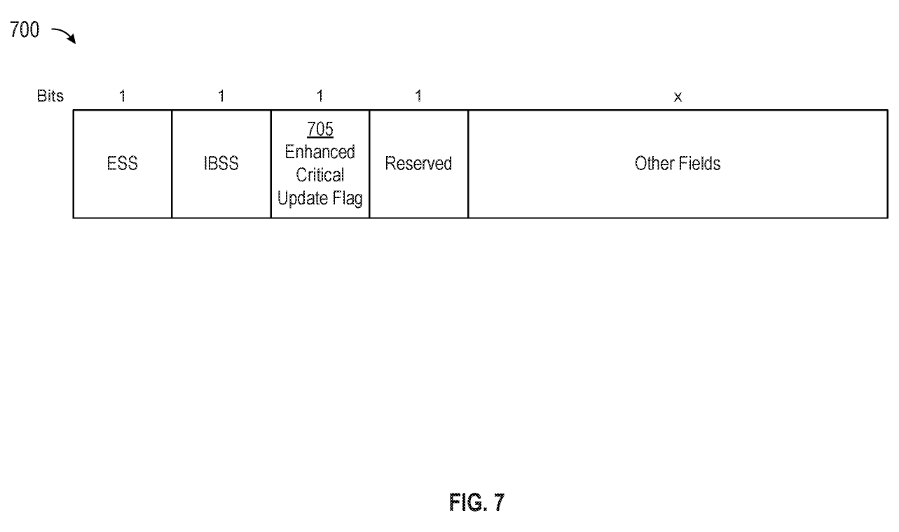

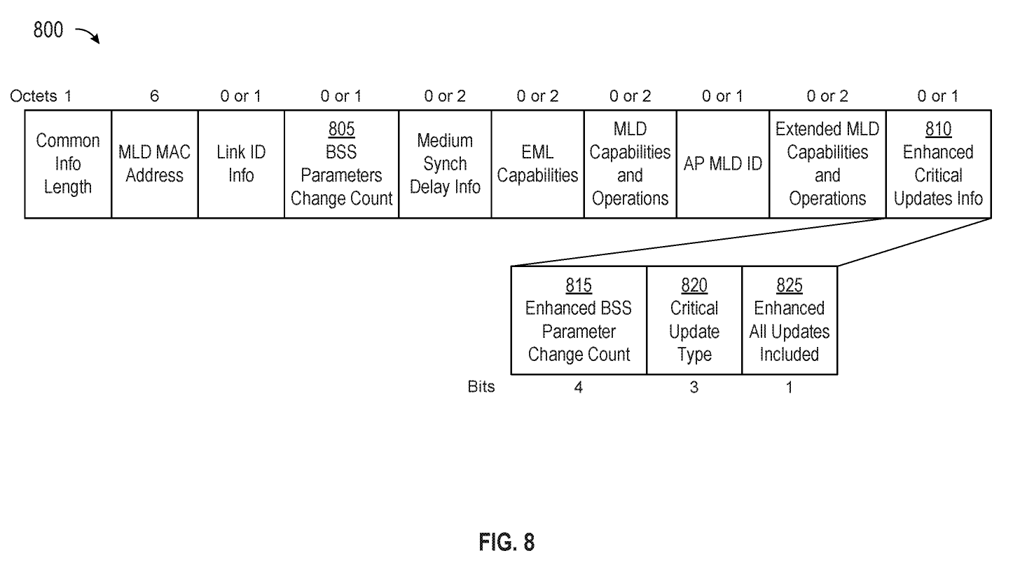

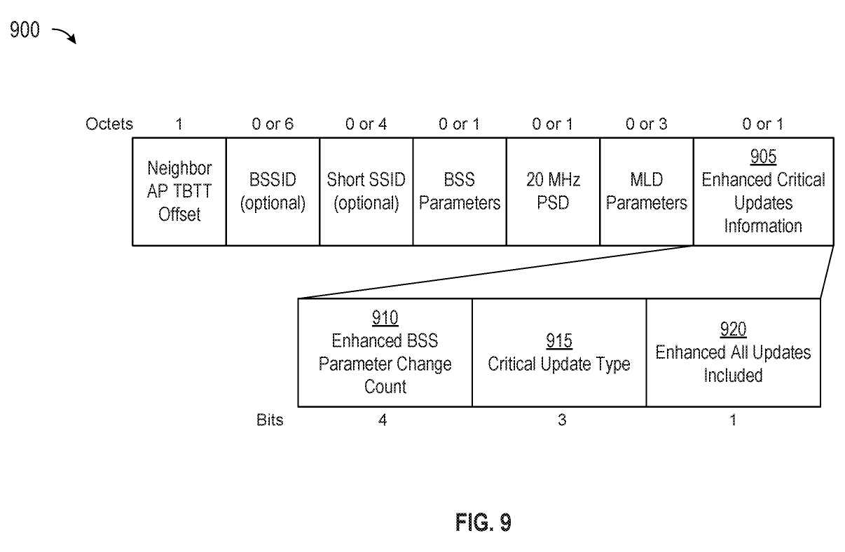

FIG. 7 illustrates a Capability Information field 700 including an enhanced CUF field 705 (also referred to as a UHR CUF field). The enhanced CUF field 705 is the UHR-defined CUF utilized in certain embodiments of the critical update signaling procedures described herein. The enhanced CUF field 705 is set to 1 in Beacon frames and Probe Response frames transmitted by a UHR AP when a critical update is being signaled (e.g., when the CPU element has been added or modified, causing the AP MLD 102 to begin the critical update notification period). As described above, the UHR CUF is set to 1 and the UHR BPCC is incremented together whenever the CPU element is added or modified in a Beacon. The UHR CUF thus provides a readily detectable one-bit indicator that allows non-AP MLDs 110 to quickly determine whether a critical update is in progress without having to inspect the full contents of the Beacon frame. Because the UHR CUF and UHR BPCC are per-link signals, the enhanced CUF field 705 in the Capability Information field 700 of a given link reflects the critical update status only for that link. Non-AP MLDs 110 monitoring other links of the AP MLD 102 learn of a critical update on a different link through the mechanisms described below with respect to FIGS. 8 and 9.

FIG. 8 illustrates a Common Info field 800 of a Basic Multi-Link element including an Enhanced Critical Updates Info field 810. The Enhanced Critical Updates Info field 810 includes an Enhanced BPCC field 815, a Critical Update Type field 820, and an Enhanced All Updates Included field 825.

As described above with respect to single link critical update signaling, the Basic Multi-Link element carried on non-affected links (e.g., other links of the AP MLD 102 when a critical update is occurring on a first link) includes the CPU element in the Per-STA Profile for the affected link in the Basic Multi-Link element. The Enhanced Critical Updates Info field 810 in the Common Info field 800 can be used with this Per-STA Profile delivery by providing a summary of the critical update status for the AP MLD 102. The Enhanced BPCC field 815 carries the current UHR BPCC value for the affected link, allowing non-AP MLDs 110 on other links to compare this value against their stored BPCC for that link and detect that a critical update has occurred. The Critical Update Type field 820 indicates the generation or type of updates that triggered the critical update (e.g., UHR updates or Wi-Fi 9 updates). The Enhanced All Updates Included field 825 indicates whether all parameters associated with the critical update are present in the current Beacon frame, corresponding to the UHR All Updates Included flag. When the Enhanced All Updates Included field 825 is set to 1, non-AP MLDs 110 receiving the Basic Multi-Link element on a non-affected link can determine that no individual Probe Request/Response exchange or other frame exchange is needed to retrieve the updated parameters for the affected link.

FIG. 9 illustrates an RNR element 900 including an Enhanced Critical Updates Info field 905. The Enhanced Critical Updates Info field 905 includes an Enhanced BPCC field 910, a Critical Update Type field 915, and an Enhanced All Updates Included field 920.

As described above, the RNR element carried in Beacon frames on non-affected links of the AP MLD 102 is one of the mechanisms by which non-AP MLDs 110 monitoring those links are informed of a critical update occurring on a different link (referred to as the reported link or APs). The RNR element 900 provides information including parameters for the other links of the AP MLD 102 and other reported APs (which can be collocated APs or in some cases non-collocated APs), and the Enhanced Critical Updates Info field 905 extends this with the critical update status for the corresponding neighbor link. The Enhanced BPCC field 910 carries the current UHR BPCC for the link described in the RNR entry; a non-AP MLD 110 that detects a change in this value relative to its stored UHR BPCC for that link knows that a critical update has occurred and can take appropriate action, such as retrieving the CPU element from the Per-STA Profile in the Basic Multi-Link element or initiating a Probe Request/Response exchange (or another frame exchange) to fetch the parameters. The Critical Update Type field 915 indicates the generation or type of the updates that triggered the critical update (e.g. UHR updates or Wi-Fi 9 updates in future), and the Enhanced All Updates Included field 920 signals whether all updated parameters are available in the current Beacon.

Together, the enhanced CUF field 705 , the Enhanced Critical Updates Info field 810 in the Basic Multi-Link element 800, and the Enhanced Critical Updates Info field 905 in the RNR element 900 form a coordinated per-link and cross-link signaling framework. A non-AP MLD 110 monitoring the affected link directly uses the CUF field 705 to detect the critical update. A non-AP MLD 110 monitoring a different link of the same AP MLD 102 uses the Enhanced BPCC in either the RNR element 900 or the Common Info field 800 of the Basic Multi-Link element to detect the update on the affected link and then retrieves the full CPU element from the Per-STA Profile of the Basic Multi-Link element for that link.

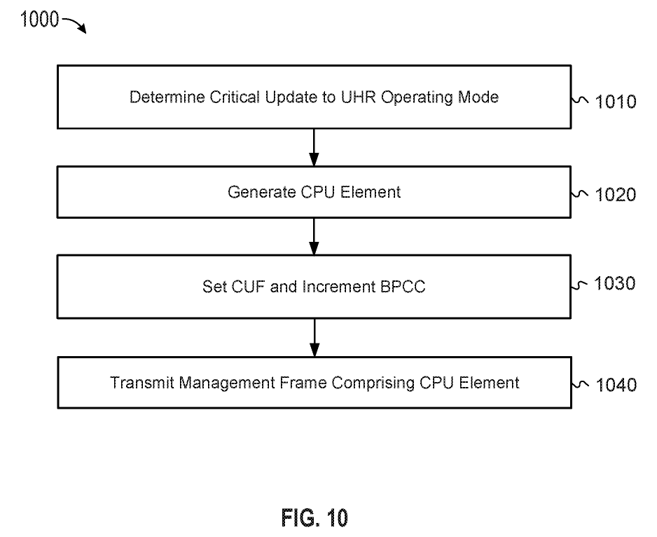

FIG. 10 illustrates a method 1000 for UHR critical update signaling performed by an AP, such as the AP MLD 102. The method 1000 includes stages 1010, 1020, 1030, and 1040.

At stage 1010, the AP determines a critical update to at least one UHR operating mode parameter. The critical update may involve enabling, disabling, or modifying parameters of one or more UHR operating modes, including NPCA, DPS, DSO, DUO, PUO, DBE, AP PPS (AP PUO), or P-EDCA. In some embodiments, the critical update comprises an update to the Basic UHR MCS and NSS Set (e.g., reducing the required MCS or NSS to conserve power or redistribute radio resources across links).

At stage 1020, the AP generates a CPU element comprising a critical update type indicator identifying the at least one UHR operating mode subject to the critical update, a critical update switch time indicating the time at which the critical update will take effect, and updated parameters associated with the critical update. when applicable. In some embodiments, the critical update switch time indicates a number of TBTTs remaining before the critical update takes effect. In other embodiments, the critical update switch time indicates a TSF time value in TUs at which the critical update takes effect. For critical updates involving a physical transition, such as an NPCA primary channel change or a DBE bandwidth change, the CPU element further comprises a maximum transition time field indicating the maximum duration for completing the transition following the critical update switch time. When multiple critical updates share the same critical update switch time, the CPU element includes a critical update type indicator for each of the affected operating modes. In some embodiments, the CPU element further includes a Link ID field identifying the link to which the critical update applies, enabling cross-link critical update signaling from a single Beacon frame. In other embodiments, the CPU element is structured as a Multi-Link element comprising a Multi-Link Control field identifying the element type, a Common Info field optionally comprising an MLD MAC Address field, and a Link Info field comprising one or more Per-STA Profile subelements, each including a Link ID, a critical update control field, a parameters presence bitmap, and updated parameters for the respective link.

At stage 1030, the AP sets the CUF (e.g., a UHR CUF) to a first value and increments the BPCC (e.g., a UHR BPCC) in response to the CPU element being added to or modified in a management frame. The BPCC is not incremented when the critical update takes effect at the time indicated by the critical update switch time, as the BPCC was already incremented at stage 1030. When all updated parameters associated with the critical update that caused the last BPCC increment are included in the management frame, the AP additionally sets an All Updates Included flag to a first value. The AP maintains the CUF at the first value and continues transmitting the CPU element in management frames for a duration based on one or more listen intervals provided by the associated STAs during association, ensuring STAs that intermittently sleep or miss frames can receive the critical update notification.

At stage 1040, the AP transmits the management frame comprising the CPU element to one or more associated STAs. The management frame may be a Beacon frame, a Probe Response frame, a Link Reconfiguration Response frame, or a (Re)Association Response frame, with the CUF carried in the Capability Information field of the frame. In some embodiments, the management frame comprises a second CPU element having a different critical update switch time, enabling the AP to simultaneously announce two critical updates that take effect at different times in a single Beacon frame. After the critical update takes effect, the AP transmits one or more management frames comprising the CPU element with a special value in the critical update switch time field indicating that the critical update has already taken effect. In some embodiments, a management frame transmitted at stage 1040 simultaneously comprises the CPU element with the special switch time value for a prior critical update that has already taken effect and a second CPU element with a future switch time for a subsequent critical update that has not yet taken effect. The AP may also transmit a Probe Response frame or a (Re)Association Response frame comprising the CPU element with the special switch time value to provide current operating mode parameters to a requesting STA outside of a critical update event.

In embodiments where the AP is an AP MLD comprising a plurality of links and the critical update occurs on a first link, stage 1040 further comprises signaling the critical update to STAs monitoring a second link by including the BPCC for the first link in an RNR element transmitted in Beacon frames on the second link and including the CPU element in a Per-STA Profile subelement corresponding to the first link within a Basic Multi-Link element transmitted on the second link. In embodiments supporting cross-link critical update signaling via a Link ID field in the CPU element, the management frame may instead include a first CPU element for the current link and a second CPU element with a Link ID identifying a second link of the AP MLD, each carrying the timing information with respect to the link identified by its respective Link ID field. In some embodiments, the AP transmits, in at least one of a Probe Response frame or an Association Response frame, a UHR Operation element comprising a UHR Operation Parameters field indicating enabled and disabled UHR operating modes and, for each enabled mode, operating mode parameters for that mode.

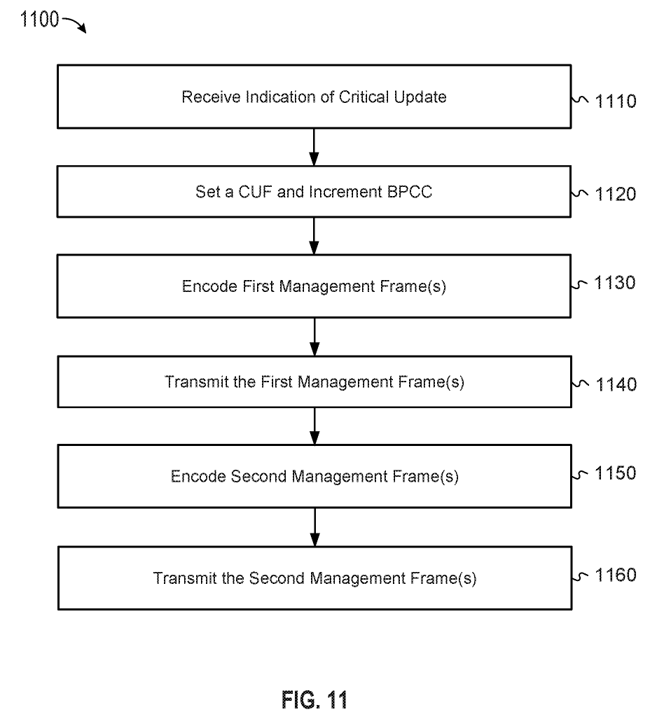

FIG. 11 illustrates a method 1100 for UHR critical update signaling performed by an AP MLD, such as the AP MLD 102. At stage 1110, the AP MLD receives an indication of a critical update to a UHR mode of operation, the critical update affecting a first affiliated AP of the AP MLD. The indication identifies the UHR mode of operation subject to the critical update and the time at which the critical update will take effect.

At stage 1120, responsive to the indication received at stage 1110, the AP MLD sets a value of the UHR CUF corresponding to the first affiliated AP to indicate the critical update, and increments the UHR BPCC value corresponding to the first affiliated AP.

At stage 1130, the AP MLD encodes one or more first management frames for transmission by the first affiliated AP. The one or more first management frames comprise information indicating the value of the UHR CUF and the UHR BPCC value corresponding to the first affiliated AP, and a CPU element including information indicating the UHR mode of operation subject to the critical update, the time at which the critical update takes effect, and one or more parameters corresponding to the UHR mode of operation. In some embodiments, the one or more first management frames are Beacon frames.

At stage 1140, the first affiliated AP transmits the one or more encoded first management frames. Transmission of the first management frames continues for a duration so that STAs that intermittently sleep or miss frames can receive the critical update notification prior to the switch time.

At stage 1150, the AP MLD encodes one or more second management frames for transmission by a second affiliated AP of the AP MLD. The one or more second management frames comprise a RNR element comprising information indicating the UHR CUF value and the UHR BPCC value corresponding to the first affiliated AP and a Basic Multi-Link element including a Per-STA Profile subelement corresponding to the first affiliated AP, the Per-STA Profile subelement including the CPU element. By including the current BPCC for the first affiliated AP in the RNR element and the full CPU element in the Per-STA Profile, the second management frames allow STAs monitoring the second affiliated AP’s link to detect the critical update on the first affiliated AP’s link and retrieve the full CPU element without switching links. In some embodiments, the one or more second management frames are Beacon frames. At stage 1160, the second affiliated AP transmits the one or more encoded second management frames.

In some embodiments, after the time the critical update takes effect, the AP MLD discontinues transmission of the first and second management frames and encodes one or more third management frames for transmission by the first affiliated AP. The one or more third management frames comprise information indicating the UHR BPCC value corresponding to the first affiliated AP, and omit the CPU element. The first affiliated AP then transmits the one or more third management frames. In these embodiments, the AP MLD further encodes one or more fourth management frames for transmission by the second affiliated AP. The one or more fourth management frames comprise a second RNR element comprising information indicating an updated value of the UHR CUF to indicate no critical update and the UHR BPCC value corresponding to the first affiliated AP; and a second Basic Multi-Link element including a second Per-STA Profile subelement corresponding to the first affiliated AP, the second Per-STA Profile subelement omitting the CPU element. The second affiliated AP then transmits the one or more fourth management frames.

In other embodiments, after the time the critical update takes effect, the AP MLD discontinues transmission of the first and second management frames and sets the value of the UHR CUF corresponding to the first affiliated AP to indicate no critical update. In these embodiments, the AP MLD encodes one or more third management frames for transmission by the first affiliated AP, the one or more third management frames comprising information indicating the updated value of the UHR CUF and the UHR BPCC value corresponding to the first affiliated AP, and further including the CPU element with a special value in the critical update switch time field indicating that the critical update has already taken effect. The first affiliated AP transmits the one or more third management frames for a predetermined period of time, enabling STAs that were in deep sleep during the pre-effective notification period to passively acquire the updated parameters from Beacon frames without issuing individual probe queries.

In some embodiments, after the time the critical update takes effect, the first affiliated AP transmits a response frame to a first wireless STA, the response frame including a UHR Operation Parameters element comprising information indicating the UHR mode of operation and the one or more parameters corresponding to that mode. In some embodiments, the response frame is a Probe Response frame transmitted in response to a Probe Request frame sent by the first wireless STA, for example when the first wireless STA detects a changed BPCC value upon waking from deep sleep and initiates an individual exchange to retrieve the updated parameters.

FIG. 12 is a block diagram of a computing device 1200. As shown in FIG. 12, computing device 1200 may include a processing unit 1210 and a memory unit 1215. Memory unit 1215 may include a software module 1220 and a database 1225. While executing on processing unit 1210, software module 1220 may perform, for example, processes for providing UHR critical update signaling. Computing device 1200, for example, may provide an operating environment for the AP MLD 102, the controller 104, the non-AP MLDs 110, the devices of the network 120, and the like. The AP MLD 102, the controller 104, the non-AP MLDs 110, the devices of the network 120, and the like may operate in other environments and are not limited to computing device 1200.

Computing device 1200 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1200 may comprise any computer operating environment, such as hand-held devices, multiprocessor systems, microprocessor-based or programmable sender electronic devices, minicomputers, mainframe computers, and the like. Computing device 1200 may also be practiced in distributed computing environments where tasks are performed by remote processing devices. The aforementioned systems and devices are examples, and computing device 1200 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 1200 on the single integrated circuit (chip).

FIG. 13 illustrates an implementation of a communications device 1300 that may implement one or more of the AP MLD 102, the controller 104, the non-AP MLDs 110, the devices of the network 120, etc. In various implementations, the communications device 1300 may comprise a logic circuit. The logic circuit may include physical circuits to perform operations described for one or more of the AP MLD 102, the controller 104, the non-AP MLDs 110, the devices of the network 120, etc., for example. As shown in FIG. 13, the communications device 1300 may include one or more of, but is not limited to, a radio interface 1310, baseband circuitry 1330, and/or the computing device 1200.

The communications device 1300 may implement some or all of the structures and/or operations for the AP MLD 102, the controller 104, the non-AP MLDs 110, the devices of the network 120, etc., storage medium, and logic circuit in a single computing entity, such as entirely within a single device. Alternatively, the communications device 1300 may distribute portions of the structure and/or operations using a distributed system architecture, such as a client station server architecture, a peer-to-peer architecture, a master-slave architecture, etc.

A radio interface 1310, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1310 may include, for example, a receiver 1315 and/or a transmitter 1320. The radio interface 1310 may include bias controls, a crystal oscillator, and/or one or more antennas 1325. In additional or alternative configurations, the radio interface 1310 may use oscillators and/or one or more filters, as desired.

The baseband circuitry 1330 may communicate with the radio interface 1310 to process, receive, and/or transmit signals and may include, for example, an Analog-To-Digital Converter (ADC) for down converting received signals with a Digital-To-Analog Converter (DAC) 1335 for up converting signals for transmission. Further, the baseband circuitry 1330 may include a baseband or PHY layer processing circuit for the PHY link layer processing of respective receive/transmit signals. Baseband circuitry 1330 may include, for example, a MAC processing circuit 1340 for MAC/data link layer processing. Baseband circuitry 1330 may include a memory controller for communicating with MAC processing circuit 1340 and/or a computing device 1200, for example, via one or more interfaces 1345.

In some configurations, PHY processing circuit may include a frame construction and/or detection module, in combination with additional circuitry such as a buffer memory, to construct and/or deconstruct communication frames. Alternatively or in addition, MAC processing circuit 1340 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method, comprising:
receiving, at an access point (AP) multi-link device (MLD), an indication of a critical update to an ultra high reliability (UHR) mode of operation, the critical update affecting a first affiliated AP of the AP MLD;
responsive to the indication:
setting a value of a UHR critical update flag corresponding to the first affiliated AP to indicate the critical update; and
incrementing a UHR basic service set (BSS) Parameters Change Count (BPCC) value corresponding to the first affiliated AP;
encoding one or more first management frames for transmission by the first affiliated AP, the one or more first management frames comprising:
information indicating the value of the UHR critical update flag, and the UHR BPCC value corresponding to the first affiliated AP, and
a critical parameters update element including information indicating a UHR mode of operation, a time the critical update takes effect, and one or more parameters corresponding to the UHR mode of operation;
transmitting, by the first affiliated AP, the one or more encoded first management frames;
encoding one or more second management frames for transmission by a second affiliated AP of the AP MLD, the one or more second management frames comprising:
a reduced neighbor report element, the reduced neighbor report element comprising information indicating the UHR critical update flag, and the UHR BPCC value corresponding to the first affiliated AP, and
a basic multilink element including a per-STA profile element corresponding to the first affiliated AP, the per-STA profile element including the critical parameters update element; and
transmitting, by the second affiliated AP, the one or more encoded second management frames.

2. The method of claim 1, further comprising:
after the time the critical update takes effect, discontinuing transmission of the first and second management frames;
encoding one or more third management frames for transmission by the first affiliated AP, the one or more first management frames comprising information indicating the UHR BPCC value corresponding to the first affiliated AP, the one or more third management frames omitting the critical parameters update element; and
transmitting, by the first affiliated AP, the one or more third management frames.

3. The method of claim 2, further comprising:
encoding one or more fourth management frames for transmission by the second affiliated AP, the one or more fourth management frames comprising:
a second reduced neighbor report element, the second reduced neighbor report element comprising information indicating an update value of the UHR critical update flag to indicate no critical update, and the UHR BPCC value corresponding to the first affiliated AP;
a second basic multilink element including a second per-STA profile element corresponding to the first affiliated AP, the second per-STA profile element omitting the critical parameters update element; and
transmitting, by the second affiliated AP, the one or more encoded fourth management frames.

4. The method of claim 1, further comprising:
after the time the critical update takes effect, discontinuing transmission of the first and second management frames;
setting a value of the UHR critical update flag corresponding to the first affiliated AP to indicate no critical update;
encoding one or more third management frames for transmission by the first affiliated AP, the one or more first management frames comprising information indicating the value of the UHR critical update flag and the UHR BPCC value corresponding to the first affiliated AP, the one or more third management frames including the critical parameters update element; and
transmitting, by the first affiliated AP, the one or more third management frames for a predetermined period of time.

5. The method of claim 1, further comprising:
after the time the critical update takes effect, transmitting, by the first affiliated AP, a response frame to a first wireless station, the response frame including a UHR operation parameters element including information indicating:
the UHR mode of operation, and
the one or more parameters corresponding to the UHR mode of operation.

6. The method of claim 5, wherein the response frame is a probe response frame transmitted in response to a probe request frame sent by the first wireless station.

7. The method of claim 1, wherein the one or more first and second management frames are beacon frames.

8. An access point (AP) multi-link device (MLD) comprising:
one or more affiliated APs;
at least one memory element for storing data; and
at least one processor for executing instructions associated with the data, wherein executing the instructions causes the AP MLD to perform operations, comprising:
receiving, at the AP MLD, an indication of a critical update to an ultra high reliability (UHR) mode of operation, the critical update affecting a first affiliated AP of the AP MLD;
responsive to the indication:
setting a value of a UHR critical update flag corresponding to the first affiliated AP to indicate the critical update; and
incrementing a UHR basic service set (BSS) Parameters Change Count (BPCC) value corresponding to the first affiliated AP;
encoding one or more first management frames for transmission by the first affiliated AP, the one or more first management frames comprising:
information indicating the value of the UHR critical update flag, and the UHR BPCC value corresponding to the first affiliated AP;
a critical parameters update element including information indicating a UHR mode of operation, a time the critical update takes effect, and one or more parameters corresponding to the UHR mode of operation;
transmitting, by the first affiliated AP, the one or more encoded first management frames;
encoding one or more second management frames for transmission by a second affiliated AP of the AP MLD, the one or more second management frames comprising:
a reduced neighbor report element, the reduced neighbor report element comprising information indicating the UHR critical update flag, and the UHR BPCC value corresponding to the first affiliated AP, and
a basic multilink element including a per-STA profile element corresponding to the first affiliated AP, the per-STA profile element including the critical parameters update element; and
transmitting, by the second affiliated AP, the one or more encoded second management frames.

9. The AP MLD of claim 8, the operations further comprising:
after the time the critical update takes effect, discontinuing transmission of the first and second management frames;
encoding one or more third management frames for transmission by the first affiliated AP, the one or more first management frames comprising information indicating the UHR BPCC value corresponding to the first affiliated AP, the one or more third management frames omitting the critical parameters update element; and
transmitting, by the first affiliated AP, the one or more third management frames.

10. The AP MLD of claim 9, the operations further comprising:
encoding one or more fourth management frames for transmission by the second affiliated AP, the one or more fourth management frames comprising:
a second reduced neighbor report element, the second reduced neighbor report element comprising information indicating an update value of the UHR critical update flag to indicate no critical update, and the UHR BPCC value corresponding to the first affiliated AP, and
a second basic multilink element including a second per-STA profile element corresponding to the first affiliated AP, the second per-STA profile element omitting the critical parameters update element; and
transmitting, by the second affiliated AP, the one or more encoded fourth management frames.

11. The AP MLD of claim 8, the operations further comprising:
after the time the critical update takes effect, discontinuing transmission of the first and second management frames;
setting a value of the UHR critical update flag corresponding to the first affiliated AP to indicate no critical update;
encoding one or more third management frames for transmission by the first affiliated AP, the one or more first management frames comprising information indicating the value of the UHR critical update flag and the UHR BPCC value corresponding to the first affiliated AP, the one or more third management frames including the critical parameters update element; and
transmitting, by the first affiliated AP, the one or more third management frames for a predetermined period of time.

12. The AP MLD of claim 8, the operations further comprising:
after the time the critical update takes effect, transmitting, by the first affiliated AP, a response frame to a first wireless station, the response frame including a UHR operation parameters element including information indicating the UHR mode of operation, and the one or more parameters corresponding to the UHR mode of operation.

13. The AP MLD of claim 12, wherein the response frame is a probe response frame transmitted in response to a probe request frame sent by the first wireless station.

14. The AP MLD of claim 8, wherein the one or more first and second management frames are beacon frames.

15. A non-transitory computer readable storage medium comprising instructions that when executed configure one or more processors of an access point (AP) multi-link device (MLD) to perform operations comprising:
receiving, at the AP MLD, an indication of a critical update to an ultra high reliability (UHR) mode of operation, the critical update affecting a first affiliated AP of the AP MLD;
responsive to the indication:
setting a value of a UHR critical update flag corresponding to the first affiliated AP to indicate the critical update; and
incrementing a UHR basic service set (BSS) Parameters Change Count (BPCC) value corresponding to the first affiliated AP;
encoding one or more first management frames for transmission by the first affiliated AP, the one or more first management frames comprising:
information indicating the value of the UHR critical update flag, and the UHR BPCC value corresponding to the first affiliated AP, and
a critical parameters update element including information indicating a UHR mode of operation, a time the critical update takes effect, and one or more parameters corresponding to the UHR mode of operation;
transmitting, by the first affiliated AP, the one or more encoded first management frames;
encoding one or more second management frames for transmission by a second affiliated AP of the AP MLD, the one or more second management frames comprising:
a reduced neighbor report element, the reduced neighbor report element comprising information indicating the UHR critical update flag, and the UHR BPCC value corresponding to the first affiliated AP, and
a basic multilink element including a per-STA profile element corresponding to the first affiliated AP, the per-STA profile element including the critical parameters update element; and
transmitting, by the second affiliated AP, the one or more encoded second management frames.

16. The non-transitory computer readable storage medium of claim 15, the operations further comprising:
after the time the critical update takes effect, discontinuing transmission of the first and second management frames;
encoding one or more third management frames for transmission by the first affiliated AP, the one or more first management frames comprising information indicating the UHR BPCC value corresponding to the first affiliated AP, the one or more third management frames omitting the critical parameters update element; and
transmitting, by the first affiliated AP, the one or more third management frames.

17. The non-transitory computer readable storage medium of claim 16, the operations further comprising:
encoding one or more fourth management frames for transmission by the second affiliated AP, the one or more fourth management frames comprising:
a second reduced neighbor report element, the second reduced neighbor report element comprising information indicating an update value of the UHR critical update flag to indicate no critical update, and the UHR BPCC value corresponding to the first affiliated AP, and
a second basic multilink element including a second per-STA profile element corresponding to the first affiliated AP, the second per-STA profile element omitting the critical parameters update element; and
transmitting, by the second affiliated AP, the one or more encoded fourth management frames.

18. The non-transitory computer readable storage medium of claim 15, the operations further comprising:
after the time the critical update takes effect, discontinuing transmission of the first and second management frames;
setting a value of the UHR critical update flag corresponding to the first affiliated AP to indicate no critical update;
encoding one or more third management frames for transmission by the first affiliated AP, the one or more first management frames comprising information indicating the value of the UHR critical update flag and the UHR BPCC value corresponding to the first affiliated AP, the one or more third management frames including the critical parameters update element; and
transmitting, by the first affiliated AP, the one or more third management frames for a predetermined period of time.

19. The non-transitory computer readable storage medium of claim 15, the operations further comprising:
after the time the critical update takes effect, transmitting, by the first affiliated AP, a response frame to a first wireless station, the response frame including a UHR operation parameters element including information indicating the UHR mode of operation and the one or more parameters corresponding to the UHR mode of operation.

20. The non-transitory computer readable storage medium of claim 19, wherein the response frame is a probe response frame transmitted in response to a probe request frame sent by the first wireless station.

21. The non-transitory computer readable storage medium of claim 15, wherein the one or more first and second management frames are beacon frames.
